(19) United States
(12) Patent Application Publication
(10) Pub. No.: US 2014/0361132 A1
(43) Pub. Date: Dec. 11, 2014

(54) Safety Eyeglass Case and Mounting Bracket

(71) Applicant: John T. Busby, St. Joseph, MO (US)

(72) Inventor: John T. Busby, St. Joseph, MO (US)

(21) Appl. No.: 14/072,271

(22) Filed: Nov. 5, 2013

Related U.S. Application Data
(60) Provisional application No. 61/833,156, filed on Jun. 10, 2013.

(51) Int. Cl. A45C 11/04; F16M 13/02

(52) U.S. Cl. CPC A45C 11/04; F16M 13/02
USPC 248/213.2

(57) ABSTRACT

A safety eyeglass case is provided having a mounting means for use with a power tool with an elongated central shaft. At least one (1) securing mount are each provided with apertures and securing bolts to operatively attach the case to the shaft of a worker's tool. A user then has safety eyeglasses stored with the tool for immediate disposal and access.

### RELATED APPLICATIONS

The present invention was first described in and claims the benefit of U.S. Provisional Application No. 61/833,156, filed Jun. 10, 2013, the entire disclosures of which are incorporated herein by reference.

### FIELD OF THE INVENTION

The present invention relates to a safety eyeglass case and accompanying mounting bracket to secure the case to a power tool and thereby stow safety glasses in a convenient manner for ready and immediate access.

### BACKGROUND OF THE INVENTION

The use of safety glasses or protective eyewear has increased in both work and industrial environments. They are no longer only seen at construction sites and industrial establishments throughout the country, but at homes and commercial environments as well. Their use has resulted in reduced eye injuries, and an overall improvement in safety. One (1) area in which eyewear is typically used, or should be used, is when operating a string style trimmer when performing landscaping, or yard work. The possibility of grass clippings, stones, twigs, and the like, being thrown up into the operator's eyes is very real. One (1) of the most frequently heard excuses as to why an operator will not wear safety glasses is that they cannot be found, they are lost, or they take too long to go and get them. Then, when they are found, they are broken, scratched, or otherwise damaged. Accordingly, there exists a need for a means by which safety glasses can be provided in more ready access to be more easily and properly utilized when operating a string style trimmer or similar power tool.

### SUMMARY OF THE INVENTION

The case and mounting bracket of the present invention is a safety glasses storage case designed to mount to the shaft of a string style trimmer or similar power tool. Upon initial observation of a string-style weed trimmer equipped with the present invention, nothing appears readily different. However, after closer inspection, it can be seen that there is a safety glasses case mounted to the shaft of the weed trimmer near the shaft handle grip. The case has a hinged lid that snap locks closed and will hold one pair of safety glasses complete with side shields. The case is attached to the shaft of the trimmer using the attached mounting brackets that are sized to fit a variety of circular power tool shafts, but may also be adapted to fit other shaft shapes as well. These features ensure that safety glasses will always be readily available when beginning operation of the power tool, and provides a handy place for storage where they will not get damaged or scratched.

Thus, when the present invention meets the need for a way to keep and store protective safety glasses when not using the tool, but also keeps them at ready access in an immediate location to encourage their consistent use, which results in better safety and protection for the operator.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is an isometric view of a safety eyeglass case 20 with mounting bracket assemblies 10 affixed to a round shaft of a work tool 105 in accordance with the preferred embodiment of the present invention;

FIG. 2 is another isometric view of an open safety eyeglass case 20 with mounting bracket assemblies 10 in accordance with the preferred embodiment of the present invention; and,

FIG. 3 is an isometric view of the bottom of the safety eyeglass case 20 depicted with an exploded view of the mounting bracket assemblies 10 in accordance with the preferred embodiment of the present invention.

### DESCRIPTIVE KEY

10 mounting bracket assembly

20 case

22 lower shell

24 lower shell bottom

26 lower shell side

32 bracket base

34 base passageway

36 channel

42 upper shell

44 top

46 upper shell side

52 hinge

54 interior

62 lower bracket segment

64 bracket passageway

66 bracket aperture

71 threaded fastener

100 safety glasses

105 work tool

### DETAILED DESCRIPTION OF THE PREFERRED EMBODIMENT

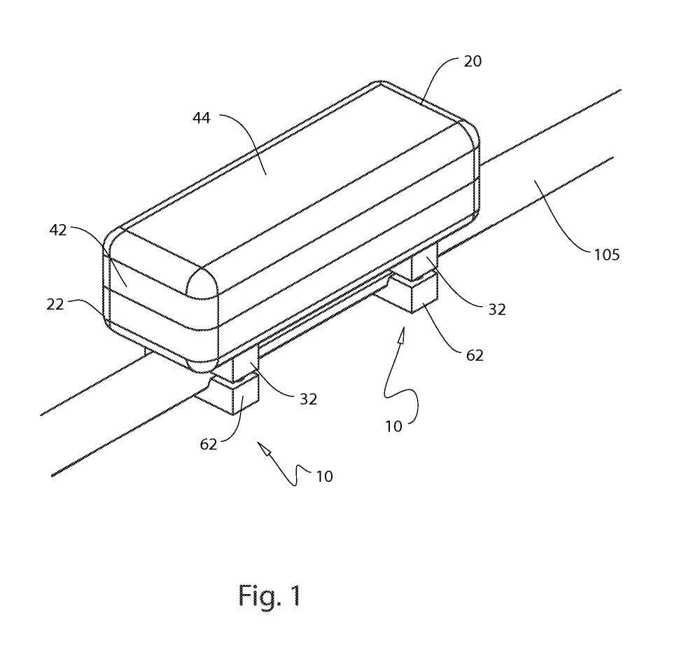

The best mode for carrying out the invention is presented in terms of its preferred embodiment, herein depicted within FIGS. 1 through 3. However, the invention is not limited to the described embodiment and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

The terms “a” and “an” herein do not denote a limitation of quantity, but rather denote the presence of at least one of the referenced items.

The present invention describes a safety eyeglass case 20 with mounting bracket assemblies 10 (herein referred to as the “case”), which provides a means to attach a pair of safety glasses 100 to the round shaft of a work tool 105 so that said safety glasses 100 are available for use by the tool user. There should be sufficient space within the interior 54 of the case 20 for the additional disposition of a pair of collapsible foam earplugs.

Referring now to FIG. 1, an isometric view of the case 20 according to the preferred embodiment of the present invention, is disclosed. The case 20 is comprised of an upper shell 42 and a lower shell 22 which are constructed preferably of a rigid thermoplastic, or other such material, as two (2) individual parts in an injection molding process. The lower shell 22 is comprised of a planar bottom 24 with a wrap-around side 26 joined along all abutting edges and formed in one (1) piece to incorporate two (2) bracket base 32 portions of the bracket assembly 10 located subjacent to said bottom 24. Each bracket base 32 is provided with a base passageway 34 which is a hemispherical void in said bracket base 32 to conform to the cylindrical shaft of the work tool 105. In some embodiments the bottom 24 may have contours other than a strictly planar configuration without limiting the scope of the case 20. A plurality of threaded channels 36 in each bracket base 32 enable fastening to correspondingly joined lower bracket 62.

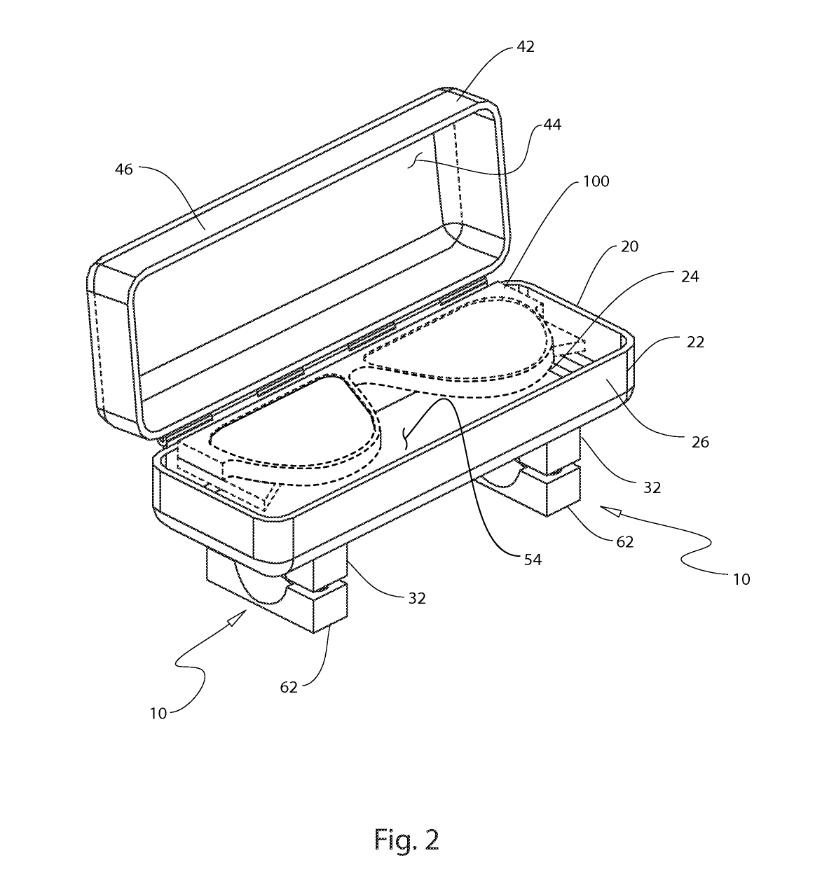

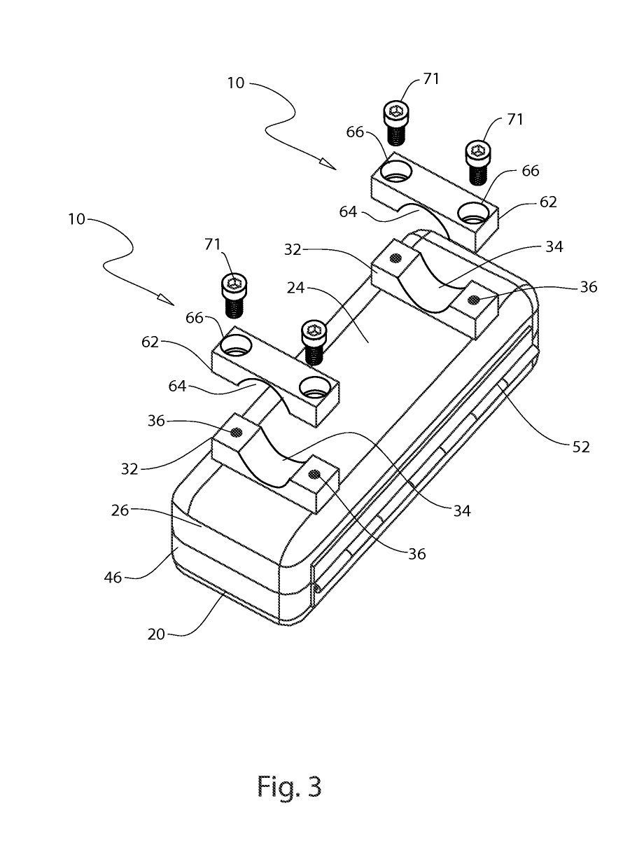

Referring now to FIGS. 2, an isometric view of the case 20 in an open configuration, and FIG. 3, an isometric view of the bottom of the case 20, according to the preferred embodiment of the present invention, are disclosed. The upper shell 42 is comprised of a contoured top 44 with a contiguous wrap-around upper side 46 formed in one (1) piece. The upper shell 42 and the lower shell 22 are attached to opposite leaves of a hinge 52 preferably by means of rivets, or other such fasteners, and form an interior 54 of sufficient volume for the storage of a pair of safety eyeglasses 100. The hinge 52 would preferably incorporate a spring, or spring like device to hold the case 20 in a closed configuration.

The lower bracket segment 62 of the bracket assemblies 10 is comprised preferably of a rigid thermoplastic, or other such material and formed with a bracket passageway 64 similar to the base passageway 34 in the bracket base 32 pieces previously discussed. When each bracket base 32 is conjoined with a corresponding lower bracket 62 the base passageway 34 and the bracket passageway 64 form a joined passageway permitting entrance of a cylindrical shaft of a work tool 105. Disposed in the lower bracket segments 62 is a plurality of bracket apertures 66 for the purpose of installing threaded fasteners 71 to clamp the case 20 to a work tool 105.

The preferred embodiment of the present invention can be utilized by the enabled user in a simple and straightforward manner with little or no training. After initial purchase or acquisition of the case 20, it would be installed as indicated in FIG. 1. The method of installing and utilizing the case 20 may be achieved by performing the following steps: installing the case 20 onto a work tool 105 by fitting a cylindrical shaft of said work tool 105 into the base passageways 34 of each bracket base 32; fitting the bracket passageway 64 of a lower bracket segment 62 onto the work tool 105 shaft opposite from a bracket base 32; aligning the bracket apertures 66 with the threaded channels 36; installing the required number of threaded fasteners 71; repeating the procedure to complete the installation of the remaining lower bracket segments 62; and inserting a user-supplied pair of safety glasses 100 into the case 20.

The foregoing descriptions of specific embodiments of the present invention have been presented for purposes of illustration and description. They are not intended to be exhaustive or to limit the invention and method of use to the precise forms disclosed. Obviously many modifications and variations are possible in light of the above teaching. The embodiment was chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A case comprising:
an upper shell operatively affixed to a lower shell;
a first mounting bracket integrated into an outer surface of said lower shell;
a second mounting bracket; and,
a fastening means to secure said first mounting bracket to said second mounting bracket.

2. The case of claim 1, wherein said case further comprises a hinge disposed between said upper shell and said lower shell.

3. The case of claim 2, wherein said hinge further comprises a spring mechanism to operatively hold said upper and said lower shells in a closed configuration.

4. The case of claim 1, wherein said first mounting bracket comprises at least one side having a semi-circular aperture.

5. The case of claim 4, wherein said second mounting bracket comprises at least one side having a semi-circular aperture.

6. The case of claim 5, wherein said case further comprises a third mounting bracket affixed to said outer surface of said lower shell.

7. The case of claim 6, wherein said third mounting bracket comprises at least one side having a semi-circular aperture.

8. The case of claim 7, wherein said case further comprises a fourth mounting bracket operatively affixed to said third bracket.

9. The case of claim 8, wherein said fourth mounting bracket comprises at least one side having a semi-circular aperture.

10. The case of claim 9, wherein said semi-circular apertures of said first and said second brackets align to form a first circular aperture when said first and said second brackets are fastened to one another, and said third and said fourth brackets align to form a second circular aperture when said third and said fourth brackets are fastened to one another, wherein said first and said second circular apertures align axially.

11. A case comprising:
an upper shell hingedly affixed to a lower shell;
a first mounting bracket integrated into an outer surface of said lower shell;
a second mounting bracket;
a third mounting bracket integrated into said outer surface of said lower shell;
a fourth mounting bracket; and,
a fastening means to secure said first mounting bracket to said second mounting bracket and said third mount bracket to said fourth mounting bracket.

12. The case of claim 11, wherein said hinge further comprises a spring mechanism to operatively hold said upper and said lower shells in a closed configuration.

13. The case of claim 11, wherein said first mounting bracket comprises at least one side having a semi-circular aperture.

14. The case of claim 13, wherein said second mounting bracket comprises at least one side having a semi-circular aperture.

15. The case of claim 14, wherein said semi-circular apertures of said first and said second brackets align to form a first circular aperture when said first and said second brackets are fastened to one another.

16. The case of claim 11, wherein said third mounting bracket comprises at least one side having a semi-circular aperture.

17. The case of claim 15, wherein said fourth mounting bracket comprises at least one side having a semi-circular aperture.

18. The case of claim 17, wherein said semi-circular apertures of said third and said fourth brackets align to form a second circular aperture when said third and said fourth brackets are fastened to one another.

19. The case of claim 11, wherein said fastening means further comprises a plurality of threaded fasteners.

20. A case comprising:
an upper shell and a lower shell having a locking hinge operatively disposed there between;
a first mounting bracket integrated into an outer surface of said lower shell and comprising at least one side having a semi-circular aperture;
a second mounting bracket comprising at least one side having a semi-circular aperture;
a third mounting bracket integrated into an outer surface of said lower shell and comprising at least one side having a semi-circular aperture;
a fourth mounting bracket comprising at least one side having a semi-circular aperture;
a fastening means to secure said first mounting bracket to said second mounting bracket and said third mount bracket to said fourth mounting bracket.
